(19) United States
(12) Patent Application Publication
(10) Pub. No.: US 2026/0367456 A1
(43) Pub. Date: Nov. 19, 2026

(54) Display Panel and Electronic Device

(71) Applicant: HKC CORPORATION LIMITED, Shenzhen (CN)

(72) Inventors: Huayin WEN, Shenzhen (CN); Jiewei LI, Shenzhen (CN)

(73) Assignee: HKC CORPORATION LIMITED, Shenzhen (CN)

(21) Appl. No.: 19/676,675

(22) Filed: May 13, 2026

(30) Foreign Application Priority Data
May 14, 2025 (CN) 202510619052.5

(51) Int. Cl. G02F 1/157; G02F 1/155

(52) U.S. Cl. CPC G02F 1/157; G02F 1/155

(57) ABSTRACT

Disclosed are a display panel and an electronic device. The display panel includes: a plurality of color resist regions and a plurality of reflection regions, the reflection regions being provided below the color resist regions respectively. The color resist region includes a color resist portion and a blank area, and a central point of the blank area coincides with a central point of the color resist region; light incident from the blank area is at least partially shone onto the reflection region, and the reflection region is at least configured to reflect the light incident from the blank area to the corresponding color resist region. By providing the blank area in the middle of the color resist region, all the light is reflected through the reflection area to the corresponding color resist region above and exits.

### CROSS-REFERENCE TO RELATED APPLICATIONS

The present disclosure claims all the benefits of the Chinese patent application No. 202510619052.5, filed on May 14, 2025 before the China National Intellectual Property Administration of the People's Republic of China, entitled “Display Panel and Electronic Device”, which is explicitly incorporated herein by reference in its entirety.

### FIELD

The present disclosure relates to the technical field of display, in particular to a display panel and an electronic device.

### BACKGROUND

In the display structure of devices such as a color e-paper, there are problems such as low luminance, low color saturation and low contrast currently. To solve the problem of low luminance, a commonly used technical method is to add a blank area on a side of each color resist to increase pixel display luminance, with the color resist and the blank area each occupying half of the area. However, as the blank area increases, natural light incident from the blank area may, after reflection, affect chromaticity of a color resist adjacent thereto, which may be prone to display color shift at large viewing angles.

### SUMMARY

A first aspect of the embodiments of the present disclosure provides a display panel including: a plurality of color resist regions and a plurality of reflection regions, the reflection regions being provided below the color resist regions respectively; the color resist region includes a color resist portion and a blank area, and a central point of the blank area coincides with a central point of the color resist region; light incident from the blank area is at least partially is shone onto the reflection region, and the reflection region is at least configured to reflect the light incident from the blank area to the corresponding color resist region.

In a possible embodiment, on a cross section in a first direction, the reflection region includes: two first reflective members arranged at a lower-left portion and a lower-right portion of the reflection region, respectively, and the two first reflective members have opposite inclined surfaces and are bilaterally symmetrical with respect to a central axis of the reflection region; and the two first reflective members are at least configured to reflect the light incident from the blank area to the corresponding color resist region.

In a possible embodiment, the first reflective member is a prism; or
the first reflective member is a transparent base material, and an area defined by the inclined surfaces of the two first reflective members is formed by etching the transparent base material.

In a possible embodiment, the reflection region further includes a second reflective member located between the two first reflective members, the second reflective member is bilaterally symmetrical with respect to the central axis of the reflection region, the second reflective member has two side surfaces, and each of the side surfaces is connected to a bottom of one of the first reflective members; light incident from the blank area is reflected by the two side surfaces of the second reflective member and the inclined surfaces of the first reflective members, and then exits from the color resist region at a plurality of angles.

In a possible embodiment, the display panel further includes: a black light-absorbing layer disposed below the reflection region; the first reflective member is a transparent base material, and an area defined by the inclined surfaces of the two first reflective members is filled with a composite material with a variable refractive index; in a case where the refractive index of the composite material is adjusted to be greater than a refractive index of the transparent base material, light incident from the blank area is reflected by the reflection region and then exits from the color resist region; in a case where the refractive index of the composite material is adjusted to be equal to a refractive index of the transparent base material, light incident from the blank area is incident via the reflection region onto the black light-absorbing layer.

In a possible embodiment, the first reflective member is a prism; an area defined by the inclined surfaces of the two first reflective members is filled with an electrochromic material; the display panel further includes an electrode disposed above the electrochromic material; in a case where the electrochromic material is adjusted to a transparent state through the electrode, light incident from the blank area is reflected by the reflection region and then exits from the color resist region; in a case where the electrochromic material is adjusted to a black state through the electrode, the light incident from the blank area is incident onto the black electrochromic material and is not reflected.

In a possible embodiment, the first reflective member is filled with an electrochromic material; the display panel further includes an electrode disposed at a bottom of the first reflective member; in a case where the electrochromic material is adjusted to a transparent state through the electrode, light incident from the blank area is reflected by the reflection region and then exits from the color resist region; in a case where the electrochromic material is adjusted to a black state through the electrode, light incident from the blank area is incident onto the black first reflective member and is not reflected.

In a possible embodiment, a light-transmitting region is disposed between the adjacent color resist regions, and has a transparent middle and a reflective side; the adjacent reflection regions abut against each other, and a position where the adjacent reflection regions abut against each other is aligned with a central axis of the light-transmitting region between the corresponding adjacent color resist regions; light incident from the light-transmitting region is reflected by the two side surfaces of the second reflective member and the inclined surfaces of the first reflective members, and then exits from the color resist region and the light-transmitting region at a plurality of angles.

In a possible embodiment, a black matrix is disposed between the adjacent color resist regions, and an edge of the reflection region is aligned with an edge of the corresponding color resist region.

In a possible embodiment, an area of the blank area accounts for less than 50% of an area of the color resist region where the blank area is located.

A second aspect of the embodiments of the present disclosure provides an electronic device including the display panel of any one embodiment of the first aspect.

The embodiments of the present disclosure provide a display panel and an electronic device. The display panel includes: a plurality of color resist regions and a plurality of reflection regions, in which the reflection regions are provided below the color resist regions respectively; the color resist region includes a color resist portion and a blank area, and a central point of the blank area coincides with a central point of the color resist region; light incident from the blank area is at least partially shone onto the reflection region, and the reflection region is at least configured to reflect the light incident from the blank area to the corresponding color resist region. Thus, by providing the blank area between the color resist portions of the same color, that is, providing the blank area in the middle of the color resist region rather than on the side of the color resist region, on the basis of improving the luminance, compared with providing a blank between color resists of different colors, light incident above the color resists of the same color may be concentrated and guided to a corresponding reflection region below the color resists of the same color. In addition, based on the reflection region corresponding to each color resist region, the incident light may be reflected upward more concentratedly and not reflected to other color resist regions.

### BRIEF DESCRIPTION OF THE DRAWINGS

Drawings, provided for further understanding of the present disclosure and forming a part of the present disclosure, are used to explain the present disclosure together with embodiments of the present disclosure rather than to limit the present disclosure.

FIG. 1 is a schematic structural diagram of a display panel according to an embodiment of the present disclosure;

FIG. 2 is a first schematic top-view structural diagram of a color resist region according to an embodiment of the present disclosure;

FIG. 3 is a second schematic top-view structural diagram of a color resist region according to an embodiment of the present disclosure;

FIG. 4 is a first schematic structural diagram of a display panel according to an embodiment of the present disclosure;

FIG. 5 is a second schematic structural diagram of a display panel according to an embodiment of the present disclosure;

FIG. 6 is a third schematic structural diagram of a display panel according to an embodiment of the present disclosure;

FIG. 7 is a fourth schematic structural diagram of a display panel according to an embodiment of the present disclosure;

FIG. 8 is a first schematic diagram showing a structure and an optical path of a display panel according to an embodiment of the present disclosure;

FIG. 9 is a second schematic diagram showing a structure and an optical path of a display panel according to an embodiment of the present disclosure;

FIG. 10 is a third schematic diagram showing a structure and an optical path of a display panel according to an embodiment of the present disclosure;

FIG. 11 is a fourth schematic diagram showing a structure and an optical path of a display panel according to an embodiment of the present disclosure;

FIG. 12 is a fifth schematic diagram showing a structure and an optical path of a display panel according to an embodiment of the present disclosure; and

FIG. 13 is a sixth schematic diagram showing a structure and an optical path of a display panel according to an embodiment of the present disclosure.

### DETAILED DESCRIPTION

In order to make one skilled in the art better understand the solution of the present disclosure, the technical solutions in the embodiments of the disclosure will be clearly and fully described in combination with the accompanying drawings in the embodiments of the disclosure. Obviously, the embodiments to be described are part of embodiments but not all embodiments of the disclosure. Based on the embodiments in the disclosure, all other embodiments obtained by those of ordinary skill in the art without inventive work shall fall within the scope of the disclosure. It should be noted that the embodiments of the present disclosure and the characteristics in the embodiments can be combined with each other under the condition of no conflict.

It should be noted that the specification and claims of the present disclosure and the terms “first”, “second”, and the like in the drawings are used to distinguish similar objects and are not necessarily used to describe a particular order or sequential order. It is to be understood that the data so used are interchangeable under appropriate circumstances, such that the embodiments of the present disclosure described herein can be implemented in a sequence other than those illustrated or described herein. Further, the terms “comprise”, “have”, and any variations thereof are intended to cover a non-exclusive inclusion, such that a process, method, system, product, or apparatus that includes a series of steps or elements is not necessarily limited to those steps or elements explicitly listed, but may include other steps or elements not explicitly listed or inherent to the process, method, product, or apparatus.

Although a plurality of elements, components, regions, layers and/or sections can be described herein with the terms first, second, third, and the like, they should not be limited by these terms. These terms may be only configured to distinguish one element, component, region, layer or section from another ones. Terms such as “first” and “second” and other numerical terms do not imply sequence or order when used herein unless clearly indicated in the context. Accordingly, the first element, component, region, layer or section discussed below may be referred to as a second element, component, region, layer or section without departing from teachings of the exemplary embodiments.

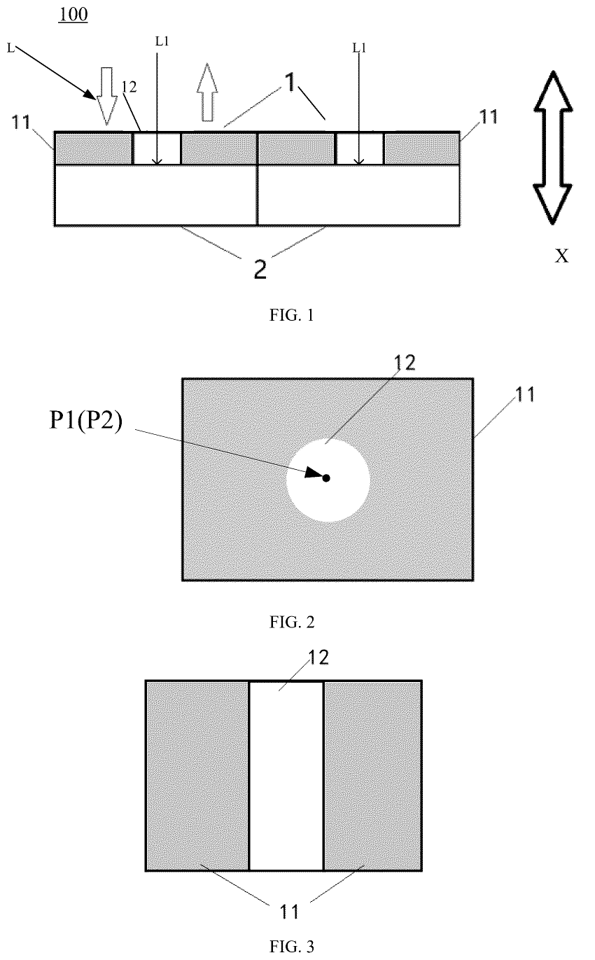

The present embodiments provide a display panel. FIG. 1 is a schematic structural diagram of a display panel according to an embodiment of the present disclosure. As shown in FIG. 1, the display panel 100 includes: a plurality of color resist regions 1 and a plurality of reflection regions 2, where each of the color resist regions 1 is provided with one of the reflection regions 2 below the color resist region.

The color resist region 1 includes a color resist portion 11 and a blank area 12, and a central point P1 of the blank area 12 coincides with a central point P2 of the color resist region 1.

Light L incident from the blank area 12 is at least partially irradiated onto the reflection region 2, and the reflection region 2 is configured to at least reflect the light L1 incident from the blank area 12 to the corresponding color resist region 1.

Here, FIG. 1 may be a schematic cross-sectional view along a first direction X, where the first direction X may be a vertical direction. The color resist region 1 may include the color resist portion 11 and the blank area 12, and the color resist portion 11 is configured to emit light to provide a display of a corresponding color.

In an embodiment, the blank area 12 is not directly connected to the edge of an adjacent color resist region 1. For example, a color resist portion 11 may be provided between the blank area 12 and the adjacent color resist region 1, thereby facilitating avoidance of direct entry of reflected light into the adjacent color resist region 1.

In an embodiment, in a top-view direction, i.e., in a cross-section perpendicular to the first direction, the color resist region 1 may have a shape such as a quadrilateral, the blank area 12 may have a shape such as a rectangle, circle or other shapes, and the reflection region 2 may be configured to have a V-shaped cross-section along the first direction, such as a triangular pyramid, a quadrangular pyramid, or a cone, among others. The color resist portion 11 may surround the blank area 12, for example, as shown in the top-view of FIG. 2. Alternatively, one color resist region 1 may be divided into two color resist portions 11 based on the blank area 12, with one color resist portion 11 and the other color resist portion 11 respectively disposed on opposite sides of the blank area 12, for example, as shown in the top-view of FIG. 3.

In the top-view direction, the blank area 12 may have a shape such as a rectangle, circle or other shapes. When the blank area 12 has a shape of a rectangle, the reflection region 2 may have a shape such as a quadrangular pyramid with a V-shaped cross-section along the first direction. When the blank area 12 has a shape of a circle, the reflection region 2 may have a shape such as a cone with a V-shaped cross-section along the first direction. When the blank area 12 has a shape of a triangle, the reflection region 2 may have a shape such as a triangular pyramid with a V-shaped cross-section along the first direction. The above is for example only and are not intended to be limiting.

The central point P1 of the blank area 12 coinciding with the central point P2 of the corresponding color resist region 1 may refer to that, in the top-view direction, i.e., in the cross-section perpendicular to the first direction, the blank area 12 is located at the center of the color resist region 1, and the central point may refer to a geometric central point. For example, a central axis of the blank area 12 may coincide with a central axis of the color resist region 1, where the central axis may refer to a central axis in the cross-section along the first direction. The color of the color resist portion 11 may be red, green, blue, or the like. The plurality of color resist regions 1 may be arranged in the same horizontal plane, and adjacent color resist regions 1 may have different colors. The color resist regions 1 in the display panel may be alternately arranged in an order of red, green and blue.

In an embodiment, a central axis of the reflection region 2 may coincide with the central axis of the corresponding color resist region 1 above the reflection region. In a case where the color resist region 1 is divided into two color resist portions 11 based on the blank area 12, the two color resist portions 11 in the color resist region 1 may have the same sizes and be bilaterally symmetrical with respective to the central axis. The blank area 12 may be located at the center of the color resist region 1, that is, the blank area 12 is bilaterally symmetrical with respective to the central axis.

In an embodiment, the reflection region 2 is configured to at least reflect light incident from the blank area 12 in the corresponding color resist region 1 back to the corresponding color resist region 1, which may refer to that the light incident from the blank area 12 in the color resist region 1 corresponding to the reflection region 2 is reflected by the reflection region 2 and then exits from the corresponding color resist region 1.

In an embodiment, two adjacent color resist regions 1 may be arranged immediately adjacent to each other. Alternatively, a black matrix 5, a light-transmitting region 6 or the like may be disposed between the two adjacent color resist regions 1.

In an embodiment, sizes of the blank area 12 may be equal to those of a color resist portion 11. For example, the length of the blank area 12 may be equal to that of the color resist portion 11 in the color resist region 1. Here, the term “length” may refer to a length in a cross-section along the vertical direction.

In an embodiment, for each color resist region 1, one reflection region 2 is correspondingly provided below the color resist region. The width of the reflection region 2 may be greater than or equal to that of the corresponding color resist region 1. Here, the terms “above,” “below,” “width,” “length,” and other descriptive terms refer to directions or sizes in the cross-section along the vertical direction.

In an embodiment, the reflection region 2 may include at least one selected from a composite material 24 with a variable refractive index, an electrochromic material 25, a prism, or the like. The bottom of the reflection region 2 may be non-planar, thereby enabling concentrated reflection of light toward the color resist region 1 above the reflection region. The height of the reflection region 2 may be related to at least one of: the length of the corresponding color resist region 1, the length of the blank area 12, or the angle at the bottom of the reflection region 2. For example, the larger the length of the corresponding color resist region 1, the larger the length of the blank area 12, or the larger the angle at the bottom of the reflection region 2, the larger the height of the reflection region 2, which facilitates the concentration of reflected light for emission through the corresponding color resist region 1.

Here, the corresponding color resist region 1 may refer to a color resist region 1 disposed above and corresponding to the reflection region 2, i.e., a color resist region 1 aligned with the reflection region 2. The corresponding reflection region 2 may refer to a reflection region 2 arranged below and corresponding to the color resist region 1, i.e., a reflection region 2 aligned with the color resist region 1. A black light-absorbing layer 3, configured to absorb light to prevent the generation of reflected light, may further be provided below the reflection region 2.

In an embodiment, the reflection region 2 is configured to reflect light, incident from the blank area 12 in the color resist region 1 corresponding to the reflection region 2, back to the corresponding color resist region 1. For example, light incident from the blank area 12 is reflected by the reflection region 2 and then exits vertically from the blank area 12; and light incident from one color resist portion 11 of the color resist region 1 is reflected by the reflection region 2 and then exits vertically from the other color resist portion 11.

In an embodiment, the reflection region 2 may further be configured such that light incident from the corresponding color resist region 1 is reflected by the reflection region 2 and then exits from the corresponding color resist region 1 at a plurality of angles.

In an embodiment, the display panel may further include a micro-prism disposed above the color resist region 1. The micro-prism may cover the color resist region 1 and is configured to convert the incident light into light that is vertically incident into the color resist region 1. For example, the thickness (i.e., height) of the micro-prism may be equal to the thickness of the color resist region 1. A planarization layer may further be disposed between the micro-prism and the color resist region 1, which is used for planarization of the color resist portion 11 to facilitate the formation of a uniform micro-prism structure.

In an embodiment, the display panel may include a bright state and a dark state. In the bright state, the reflection region 2 may be configured such that: light incident from the blank area 12 is reflected by the reflection region 2 and then exits vertically from the blank area 12, and light incident from one color resist portion 11 of the color resist region 1 is reflected by the reflection region 2 and then exits vertically from the other color resist portion 11. Or, in the bright state, the reflection region 2 may further be configured such that light incident from the corresponding color resist region 1 is reflected by the reflection region 2 and then exits from the corresponding color resist region 1 at a plurality of angles. Additionally, in the dark state, the reflection region 2 may be configured not to generate exiting light.

Here, the bright state may include, for example, a case where the refractive index of the composite material 24 is adjusted to be greater than that of the transparent base material, or a case where the electrochromic material 25 is adjusted to a transparent state via the electrode 4. The dark state may include, for example, a case where the refractive index of the composite material 24 is adjusted to be equal to that of a transparent base material, or a case where the electrochromic material 25 is adjusted to a black state via the electrode 4.

In this way, compared to providing a blank area between different colors of resist regions 1, by providing the blank area 12 within the color resist region 1, on the basis of improvement in luminance, light incident from above the color resist region 1 may be concentrated and guided toward the corresponding reflection region 2 below this color resist region 1. Furthermore, based on the reflection region 2 corresponding to each color resist region 1, the incident light may be reflected upward more concentratedly to reduce divergence and prevent reflection to other color resist regions 1. Thereby, light interference with the resist regions 1 of other colors, which may cause color shift in the display, is avoided, while improving the luminance.

In some embodiments, as shown in FIG. 4, the reflection region 2 includes: two first reflective members 21 arranged at a lower-left portion LL and a lower-right portion LR of the reflection region 2, respectively. The two first reflective members 21 have opposite inclined surfaces and are bilaterally symmetrical with respect to the central axis O1 of the reflection region 2.

The two first reflective members 21 are at least configured to reflect the light L1 incident from the blank area 12 to the corresponding color resist region 1.

In an embodiment, the micro-prism may cover the color resist region 1. For example, the thickness (i.e., height) of the micro-prism may be equal to that of the color resist region 1. A planarization layer may further be disposed between the micro-prism and the color resist region 1, which is used for planarization of the color resist region 1 to facilitate the formation of a uniform micro-prism structure.

In an embodiment, the first reflective member 21 may be a prism or may be a transparent base material. In a case where the first reflective member 21 is a transparent base material, an area defined by the inclined surfaces of the two first reflective members 21 may be formed by etching the transparent base material. The area defined by the inclined surfaces of the two first reflective members 21 may have an inverted triangular shape along the first direction, for example, it may be a region with its opening facing the color resist region 1. The length of this region close to color resist region 1, i.e., the length of the opening of this region, may be equal to or greater than the length of the color resist region 1, which facilitates the concentration of reflected light for emission through the corresponding color resist region 1, thereby preventing interference with the light emission of an adjacent color resist region 1.

In an embodiment, the cross-sectional shape of the first reflective member 21 along the first direction X in the vertical direction is a right triangle. In all embodiments of the present disclosure, descriptions regarding edges, angles, dimensions, shapes, positional relationships and the like refer to edges, angles, dimensions, shapes, positional relationships and the like in the cross-section along the vertical direction. The two first reflective members 21 being located at the lower-left portion LL and the lower-right portion LR of the reflection region 2 respectively may refer to that the right angles of the cross-sections of the two first reflective members 21 are located at the lower-left and lower-right corners of the reflection region 2 respectively. The two first reflective members 21 are bilaterally symmetrical with respective to the central axis of the reflection region.

In an embodiment, the inclined surfaces of the two first reflective members 21 may form a reflective surface having a V-shape, a trapezoidal shape, a U-shape, a W-shape, or other shapes. Light incident from the blank area 12 may be reflected by the inclined surfaces of the two first reflective members 21 and exit from the blank area 12. Light incident from one color resist portion 11 may be reflected by the inclined surfaces of the two first reflective members 21 and exit from the other color resist portion 11.

In this way, the reflection region defined by the opposite inclined surfaces of the two reflective members may reflect the incident light to the corresponding color resist region above the reflection region in a more concentrate manner, thereby further reducing the exit of light from other adjacent color resist regions and avoiding color shift at large viewing angles.

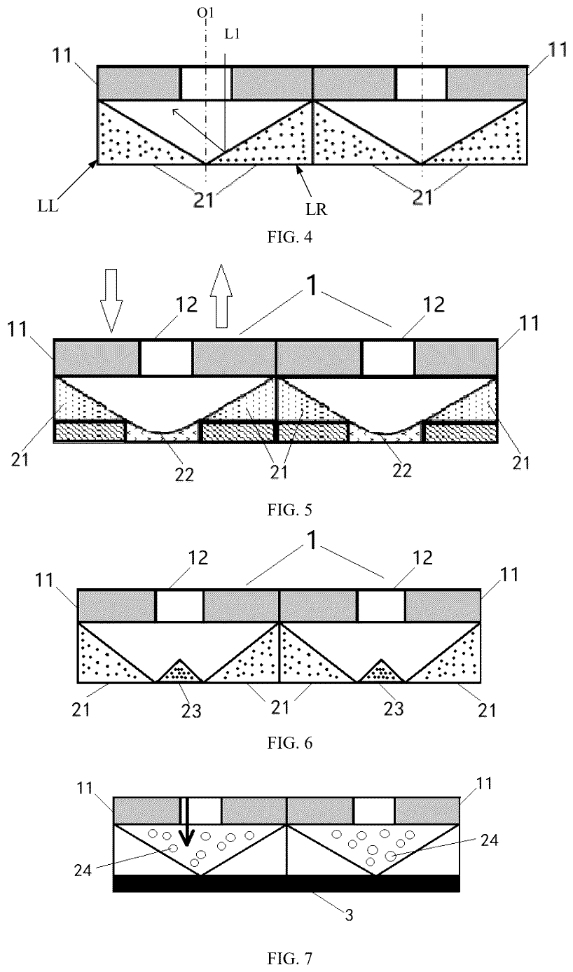

In some embodiments, as shown in FIG. 4, the bottoms of the two first reflective members 21 abut against each other; or, as shown in FIG. 5, the bottoms of the two first reflective members 21 are connected via an arc-shaped reflective member 22.

In an embodiment, if the bottoms of the two first reflective members 21 are in direct contact, the inclined surfaces of the two first reflective members 21 form a region having a V-shape or an inverted triangular shape.

The arc-shaped surface of the arc-shaped reflective member 22 may connect the inclined surfaces of the two first reflective members 21. Positions where the arc-shaped surface of the arc-shaped reflective member 22 is connected with the inclined surfaces of the first reflective members 21 may be aligned with two sides of the blank area 12, respectively. That is, a position where the arc-shaped surface is connected with the inclined surface of the left first reflective member 21 is aligned with the left side of the blank area 12, and a position where the arc-shaped surface is connected with the inclined surface of the right first reflective member 21 is aligned with the right side of the blank area 12. This allows light incident from the blank area 12 to exit from the blank area 12, and light incident from one color resist portion 11 to exit from the other color resist portion 11.

In an embodiment, the arc-shaped surface of the arc-shaped reflective member 22 may be a concave surface facing the corresponding color resist region 1 above it, thereby facilitating the concentration of reflected light incident from the upper side.

In an embodiment, a base material may be provided below or at the bottom of the reflection region 2. For example, one base material may be provided below each first reflective member 21. The length of the base material may be the same as the length of a portion of the first reflective member 21 close to the bottom of the reflection region 2, and the height of the base material may be the same as the height of the arc-shaped surface of the arc-shaped reflective member 22. Here, the height of the arc-shaped surface refers to a height between the highest point and the lowest point of the arc-shaped surface of the arc-shaped reflective member 22.

In an embodiment, the arc-shaped reflective member 22 is located at the center of the bottom of the reflection region. The arc-shaped reflective member 22 may be bilaterally symmetrical with respect to the central axis of the color resist region 1. Here, the central axis of the color resist region 1 may be the central axis of the blank area 12 within the color resist region 1.

In an embodiment, as shown in FIG. 12, a black matrix 5 may be disposed between two adjacent color resist regions 1. The edge of the reflection region 2 may be aligned with an edge of the corresponding color resist region 1. For example, adjacent reflection regions 2 are spaced apart by a predetermined distance, and the predetermined distance is equal to the length of the black matrix 5. Alternatively, the edge of the reflection region 2 may be aligned with the central axis of the black matrix 5, that is, adjacent reflection regions 2 are immediately adjacent to each other.

In an embodiment, the surface of the first reflective member 21 and the surface of the arc-shaped reflective member 22 may be total reflection surfaces. Here, the surfaces may refer to surfaces facing the color resist region 1.

In this way, through the V-shaped reflective surface formed of the surfaces in direct contact or the reflective surface formed by a combination of the first reflective member 21 and the arc-shaped reflective member 22, it is possible for the light vertically incident from one color resist portion 11 and one blank area 12 to exit vertically from another color resist portion 11 and another blank area 12. This may further improve the concentration of the reflected light, prevent the interference with other adjacent color resist regions 1, and reduce the color shift.

In some embodiments, as shown in FIG. 6, the reflection region further includes a second reflective member 23 located between the two first reflective members 21. The second reflective member 23 is bilaterally symmetrical with respect to the central axis of the reflection region. The second reflective member 23 has two side surfaces, and each of the side surfaces is connected to a bottom of one of the first reflective members 21.

Light incident from the blank area 12 is reflected by the two side surfaces of the second reflective member 23 and the inclined surfaces of the first reflective members 21, and then exits from the color resist region at a plurality of angles.

In an embodiment, the second reflective member 23 may be a triangular prism. For example, the cross-sectional shape thereof along the first direction may be a triangle, such as an isosceles triangle. A bottom surface of the second reflective member 23 may be located at the bottom of the reflection region, aligned with the bottom surfaces of the two first reflective members 21. The two side surfaces of the second reflective member 23 and the inclined surfaces of the two first reflective members 21 may form a W-shaped reflective structure. The second reflective member 23 is located at the center of the bottom of the reflection region 2, and the two first reflective members 21 are located on the left and right sides of the second reflective member 23 respectively.

In an embodiment, the central axis of the second reflective member 23 may be aligned with the central axis of the blank area 12 of the corresponding color resist region 1 above it. That is, the second reflective member 23 may be bilaterally symmetrical with respect to the central axis of the blank area 12. The central axis of the blank area 12 is the central axis of the color resist region 1.

In an embodiment, positions where the two side surfaces of the second reflective member 23 are connected to the bottoms of the first reflective members 21 may be aligned with two sides of the blank area 12 respectively. That is, a position where the left side surface is connected to the bottom of the left first reflective member 21 is aligned with the left end of the blank area 12, and a position where the right side surface is connected to the bottom of the right first reflective member 21 is aligned with the right end of the blank area 12. This allows the light incident from the blank area 12 to exit from the two color resist portions 11 after being reflected.

In an embodiment, the light vertically incident from the blank area 12 may be first reflected by the side surfaces of the second reflective member 23 and then reflected by the inclined surfaces of the first reflective members 21, thereby finally exiting from the color resist portions 11 at a plurality of angles. The inclined surface of the first reflective member 21 may be configured to reflect light incident from one color resist portion 11 such that the light exits from the blank area 12 and the other color resist portion 11.

In this way, a combination of the second reflective member 23 and the two first reflective members 21 may allow the incident light to exit from the color resist region 1 at a plurality of angles, thereby avoiding the scenario where only vertically emitted light exits, which may result in unaffected viewing performance merely at the 90-degree viewing angle while leading to poor display quality when viewed from large viewing angles. Consequently, the incident light may be emitted at wide angles after reflection, thereby improving the display performance at different viewing angles without introducing color shift.

In some embodiments, as shown in FIG. 7, the display panel further includes: a black light-absorbing layer 3 disposed below the reflection region 2. The first reflective member 21 is a transparent base material, and the area defined by the inclined surfaces of the two first reflective members 21 is filled with a composite material 24 with a variable refractive index.

In a case where the refractive index of the composite material 24 is adjusted to be greater than that of the transparent base material, light incident from the blank area 12 is reflected by the reflection region 2 and then exits from the color resist region 1.

In a case where the refractive index of the composite material 24 is adjusted to be equal to that of the transparent base material, the light incident from the blank area 12 is incident via the reflection region 2 onto the black light-absorbing layer 3.

Here, the light incident from the blank area 12 being reflected by the reflection region 2 and then exiting from the color resist region 1 may include that the light incident from the blank area 12 is reflected by the inclined surfaces of the two first reflective members 21 and then exits from the blank area 12. Additionally, it may further include that light incident from one color resist portion 11 is reflected by the inclined surfaces of the two first reflective members 21 and then exits from the other color resist portion 11.

In an embodiment, the black light-absorbing layer 3 may be disposed below and cover the reflection region 2. Light incident on the black light-absorbing layer 3 does not generate reflected light, that is, no light exits from the reflection region 2 and the color resist region 1.

In an embodiment, the composite material 24 may be a liquid crystal composite material with a variable refractive index, or the like, and the refractive index of the composite material is adjustable through a voltage. The display panel may further include an electrode 4 in contact with the composite material 24 and configured to adjust the refractive index of the composite material 24 by applying a voltage.

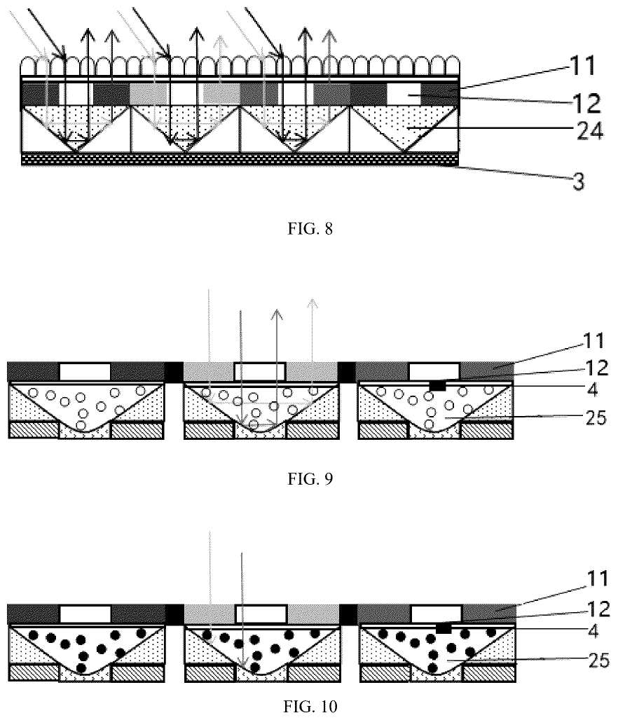

In an embodiment, as shown in FIG. 8, in a case where the refractive index of the composite material 24 is adjusted to be greater than that of the transparent base material, that is, in the bright state, the refractive index n1 of the composite material 24 is adjusted to be greater than the refractive index n2 of the transparent base material through the voltage on the electrode 4, if the base angle of the first reflective member 21 is 90°, and an incident angle of ambient light at the interface between the two materials, i.e., the angle between the light beam and the inclined surface of the first reflective member 21 is 45°, then there is n2=0.707n1. In this way, total internal reflection may be achieved at the interface between the two materials. Therefore, the refractive index of the composite material 24 being greater than that of the transparent base material may include that the refractive index of the transparent base material is equal to 0.707 times the refractive index of the composite material.

In an embodiment, in a case where the refractive index of the composite material 24 is adjusted to be equal to that of the transparent base material, that is, in the dark state, the refractive index n1 of the composite material 24 is adjusted to be equal to the refractive index n2 of the transparent base material through the voltage on the electrode 4, ambient light will be incident nearly perpendicularly onto the black light-absorbing layer 3 below and be absorbed, without generating reflected light, thereby achieving a black state display.

In this way, by filling the area defined by the inclined surfaces of the two first reflective members 21 with a material having a variable refractive index, this region may either reflect light or transmit light under different refractive index conditions. When the region reflects light, the reflected light may exit from the color resist region 1 above, thereby preventing interference with adjacent color resist regions 1. When the region transmits light, it cooperates with the light-absorbing layer below to generate no reflected light. As such, the display panel may achieve the bright state and dark state display functions.

In some embodiments, the first reflective member 21 is a prism. The area defined by the inclined surfaces of the two first reflective members 21 is filled with an electrochromic material 25. The display panel further includes an electrode 4 disposed above the electrochromic material 25.

As shown in FIG. 9, in a case where the electrochromic material 25 is adjusted to a transparent state through the electrode 4, light incident from the blank area 12 is reflected by the reflection region 2 and then exits from the color resist region 1; and light incident from one color resist portion 11 is reflected by the reflection region 2 and then exits from the other color resist portion 11.

As shown in FIG. 10, in a case where the electrochromic material 25 is adjusted to a black state through the electrode 4, the light incident from the blank area 12 is incident onto the black electrochromic material 25 and is not reflected.

In an embodiment, the light incident from the blank area 12 being reflected by the reflection region 2 and exiting from the color resist region 1 may refer to that the light incident from the blank area 12 is reflected by the inclined surfaces of the two first reflective members 21 and then exits from the blank area 12, or to that the light incident from the blank area 12 is reflected by the arc-shaped surface of the arc-shaped reflective member 22 and then exits from the blank area 12.

In an embodiment, the electrochromic material 25 may realize switching between a transparent state and a black state under the electric field applied by the electrode 4. The area defined by the inclined surfaces of the two first reflective members 21 may include a region formed by the inclined surfaces of the two first reflective members 21 and the arc-shaped surface of the arc-shaped reflective member 22.

In an embodiment, adjusting the electrochromic material 25 to the transparent state through the electrode 4 may refer to that no voltage is applied to the electrode 4, so that the electrochromic material 25 remains in the transparent state. In this case, the reflection region reflects the light incident from the blank area 12 to improve the display luminance, while the first reflective member 21 reflects the light incident from the color resist portion 11 for color display. In this case, the display panel is in the bright state.

In an embodiment, adjusting the electrochromic material 25 to the black state through the electrode 4 may refer to that the voltage is applied to the electrode 4, so that the electrochromic material 25 switches to the black state. In this case, no reflection is generated when the incident light enters the black electrochromic material 25, so that the display panel remains in the dark state.

In this way, through the electrochromic material 25, the reflection region 2 is allowed to have two color states: the transparent and black states. Accordingly, in the transparent state, the reflected light exits from the color resist region 1 above, thereby preventing interference with adjacent color resist regions 1; and in the black state, the incident light is absorbed and is not reflected, thereby allowing the display panel to achieve the bright state and dark state display functions.

In some embodiments, the first reflective member 21 is filled with an electrochromic material 25. The display panel further includes an electrode 4 disposed at the bottom of the first reflective member 21.

In a case where the electrochromic material 25 is adjusted to the transparent state through the electrode 4, the light incident from the blank area 12 is reflected by the reflection region 2 and then exits from the color resist region 1.

In a case where the electrochromic material 25 is adjusted to the black state through the electrode 4, the light incident from the blank area 12 is incident onto the black first reflective member 21 and is not reflected.

In an embodiment, the electrochromic material 25 may realize switching between a transparent state and a black state under the electric field applied by the electrode 4. The light incident from the blank area 12 being reflected by the reflection region 2 and then exiting from the color resist region 1 may include that the light incident from the blank area 12 is reflected by the side surface of the second reflective member 23 and the inclined surface of the first reflective member 21, and then exits from at least one color resist portion 11 at a plurality of angles. Additionally, it may further include that the light incident from one color resist portion 11 is reflected by the side surface of the second reflective member 23 and the inclined surface of the first reflective member 21 and then exits from the blank area 12 or the other color resist portion 11 at a plurality of angles.

In an embodiment, adjusting the electrochromic material 25 to the transparent state through the electrode 4 may refer to that no voltage is applied to the electrode 4, so that the electrochromic material 25 remains in the transparent state. In this case, the reflection region located below the blank area 12 is configured to reflect the light incident from the blank area 12. In this case, the display panel is in the bright state.

In an embodiment, adjusting the electrochromic material 25 to the black state through the electrode 4 may refer to that the voltage is applied to the electrode 4, so that the electrochromic material 25 switches to the black state. In this case, the incident light is incident onto the black first reflective member 21 directly or is reflected by the second reflective member 23 onto the black first reflective member 21 without generating reflected light, so that the display panel remains in the dark state.

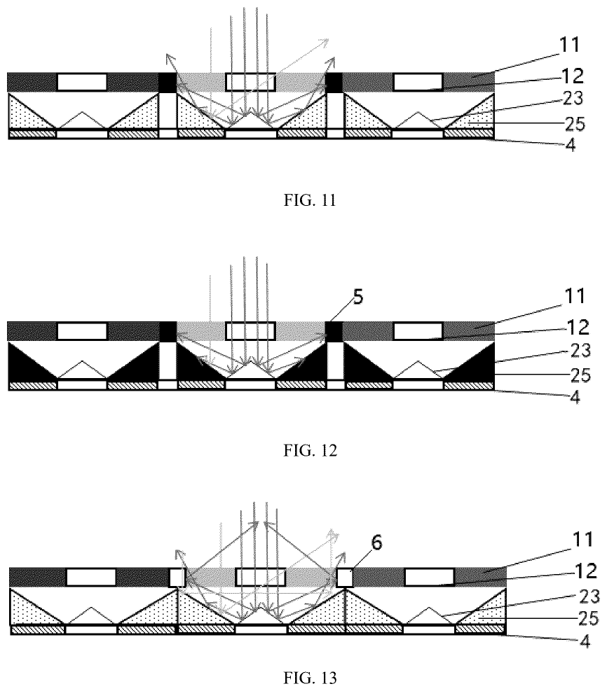

In an embodiment, a black matrix 5 is disposed between two adjacent color resist regions 1. An edge of the reflection region 2 may be aligned with an edge of the corresponding color resist region 1. For example, adjacent reflection regions 2 are spaced apart by a predetermined distance, and the predetermined distance is equal to the length of the black matrix 5. As shown in FIG. 11, in a case where the electrochromic material 25 is adjusted to the transparent state through the electrode 4, the light incident from the blank area 12 is reflected by the reflection region 2 and then exits from the color resist region 1. As shown in FIG. 12, in a case where the electrochromic material 25 is adjusted to the black state through the electrode 4, the light incident from the blank area 12 is incident onto the black first reflective member 21 and is not reflected. In this way, the black matrix 5 may block light exiting at large angles from the edge of the color resist region 1, which may result from reflection by components such as the second reflective member, thereby preventing the light from entering other adjacent color resist regions 1, so as to further improve the display effect and avoid color shift.

In some embodiments, as shown in FIG. 12, the black matrix 5 is disposed between adjacent color resist regions 1, and the edge of the reflection region 2 is aligned with the edge of the corresponding color resist region 1.

In an embodiment, the edge of the reflection region 2 may be aligned with the edge of the corresponding color resist region 1. For example, adjacent reflection regions 2 are spaced apart by a predetermined distance, and the predetermined distance is equal to the length of the black matrix 5. In this way, the black matrix 5 may block light exiting from the edge of the color resist region 1, thereby preventing the light from entering other adjacent color resist regions 1, so as to further improve the display effect and avoid color shift.

In an embodiment, the height of the black matrix 5 is the same as that of the color resist region 1.

In an embodiment, the length of the black matrix 5 may be the same as that of the blank area 12. Alternatively, it may be related to the shape and/or size of the reflection region 2. For example, in a case where the reflection region 2 includes the second reflective member 23 and the first reflective member 21, the length of the black matrix 5 may be a first length; and in a case where the reflection region 2 includes only two first reflective members 21 connected with each other, the length of the black matrix 5 may be a second length, where the first length is greater than the second length. This configuration may well prevent light from entering adjacent color resist regions 1 from the edge when the second reflective member 23 and the first reflective member 21 generate light exiting at a plurality of angles.

In this way, by providing the black matrix 5 between adjacent color resist regions 1, the light exiting from the edge of the color resist region 1 and reflected by the reflection region 2 may be blocked by the black matrix 5. This may further reduce the light reflected from the reflection region 2 into adjacent color resist regions 1, thereby further reducing color shift and improving the display effect.

In this way, through the electrochromic material 25, the reflection region 2 has two color states: the transparent and black states. Accordingly, in the transparent state, the reflected light exits from the color resist region 1 above at multiple angles, thereby preventing interference with adjacent color resist regions 1 and improving the display effect at a large viewing angle; and in the black state, the incident light is absorbed and is not reflected, thereby allowing the display panel to achieve display functions in a bright state and a dark state.

In some embodiments, as shown in FIG. 13, a light-transmitting region 6 is disposed between adjacent color resist regions 1, a transparent middle and a reflective side. Adjacent reflection regions 2 abut against each other, and a position where the adjacent reflection regions 2 abut against each other is aligned with the central axis of the light-transmitting region 6 between the corresponding adjacent color resist regions 1.

Light incident from the light-transmitting region 6 is reflected by the two side surfaces of the second reflective member 23 and the inclined surfaces of the first reflective members 21, and then exits from the color resist region and the light-transmitting region at a plurality of angles.

In an embodiment, the light-transmitting region 6 may be a region having a same height as the color resist region 1. Light incident from above the color resist region 1 may be incident from the light-transmitting region 6 to the reflection region 2, and light reflected by the second reflective member 23 and the first reflective members 21 may exit from the light-transmitting region 6 to above the color resist region 1.

In an embodiment, adjacent reflection regions 2 being in direct contact with each other may refer to that the adjacent reflection regions 2 are immediately adjacent to each other without any gap. The position where the adjacent reflection regions 2 abut against each other is aligned with the central axis of the light-transmitting region 6 between the corresponding adjacent color resist regions 1. That is, the edge of the reflection region 2 is aligned with the central axis of the light-transmitting region 6 between the corresponding color resist region 1 above the reflection region and an adjacent color resist region 1. For example, this may refer to that the right edge of the reflection region 2 is aligned with the central axis of the light-transmitting region 6 between the corresponding color resist region 1 above the reflection region and a color resist region 1 adjacent to the right side of the reflection region, and the left edge of the reflection region 2 is aligned with the central axis of the light-transmitting region 6 between the corresponding color resist region 1 above the reflection region and a color resist region 1 adjacent to the left side of the reflection region.

In this way, the reflection regions 2 are adjacent without gaps, which may increase the aperture ratio. Moreover, the light-transmitting region 6 may further improve the amount of incident light and the emission luminance of the reflected light without interfering with the display of adjacent color resist regions 1, thereby improving the utilization efficiency of ambient light.

In some embodiments, an area of the blank area 12 accounts for less than 50% of an area of the color resist region 1 where the blank area is located.

Here, the central axis of the color resist region 1 coincides with the central axis of the blank area 12, and the two color resist portions in the color resist region 1 may be symmetrically arranged with respect to the blank area 12. The area of the blank area 12 accounts for less than 50% of the area of the color resist region 1 where the blank area is located. For example, the size of the blank area 12 is less than or equal to the size of the color resist portion.

Exemplarily, the size of the color resist portion may be twice the size of the blank area

In this way, by providing the blank area 12 in the central portion of the color resist region 1, both the light incident from and the light exiting from the blank area 12 located at the center are concentrated in the central portion of the color resist region 1. On the basis of the area ratio being less than 50%, this may further reduce the chromaticity difference caused by reflected light affecting other adjacent color resist regions 1. Thus, even at large viewing angles, the light incident from the blank area 12 and then reflected by the blank area 12 remains concentrated within this color resist region 1, thereby reducing potential color shift at large viewing angles.

The embodiments of the present disclosure further provide an electronic device, which includes the display panel according to any one or more of the foregoing embodiments.

Here, the electronic device may be any device with a display function, such as a color e-paper device, a mobile phone, a watch, a tablet computer, a television, a laptop computer, or the like.

As a possible implementation, the embodiments provide a color total reflection display structure as follows.

1. A blank area (i.e., the blank area 12) is adjusted to be located between color resists of the same color. This structural change may divide the lower total reflection structure into two parts. The reflection portion directly below the blank area is used for total reflection display of external light entering the blank area, which may enable vertical incidence and vertical exit of the external light. This may resolve the color shift problem caused by the blank area (color shift resulting from the external light incident vertically but not completely exiting vertically). The total reflection structure corresponding to the color resist portion is used for the color total reflection display of the color resist.

2. The color total reflection display structure includes the color resist layer, the black matrix (BM) layer, the blank area, and the like, and the micro-prism structure is changed to a combination of triangular prisms on the left and right sides (i.e., the first reflective members 21) and a concave prism on the lower side (i.e., the arc-shaped reflective member 22), with surfaces of the prism being total reflection surfaces. An electrochromic material is added in the central portion of the prism structure, which switches from a transparent state to a black state in an electric field. The position of the electrode is changed to the upper side of the electrochromic portion.

In an ON state, the electrode is not energized, and the electrochromic material is in the transparent state. The concave structure below the blank area reflects incident light from the blank area to improve display luminance, while the triangular prism portion reflects light incident from the color resist portions for color display. This structural design may also reduce the divergence of natural light in the blank area, thereby reducing color shift and improving display luminance. In an OFF state, the electrode is energized, and the electrochromic material turns black. At this time, no natural light enters, thus the total reflection display is in the OFF state, i.e., in the black state.

3. The color total reflection display structure includes: a color resist layer and a black matrix (BM) layer, which are used for color display and light shielding respectively; a blank area located between color resists of the same color, used to improve the luminance of the reflective display; a micro-prism structure (i.e., the second reflective member 23) located directly below the blank area, with its surface designed as a total reflection surface for adjusting light; an electrically controlled material portion (i.e., the first reflective member 21) capable of switching from a black light-absorbing state to a transparent reflective state under electrical action, for example, an electrophoretic material, used to control the ON/OFF state of the display; and a control electrode used to apply a voltage to the electrically controlled material portion.

In the ON state of the reflective display, the electrode is energized, and the electrically controlled material portion is in the reflective state. At this time, light entering from the blank area is incident onto the lower triangular prism, and after a plurality of reflections, the light ultimately exits from the color resist region for display. Since color resists on both sides of the blank area are color resists of the same color and the micro-prism structure is in a shape of an isosceles triangle, the light incident from the blank area is evenly distributed to the color resist portions on both sides, thus avoiding the color shift problem.

In the OFF state of the reflective display, the electrode is not energized, and the electrically controlled material portion is in the black light-absorbing state. At this time, light incident from both the blank area and the color resist region is ultimately absorbed and cannot exit for display, thereby achieving the OFF state of the reflective display, i.e., the black mode.

4. Spaced areas are removed and adjacent structures are directly designed in the micro-prism structure, thereby achieving a large display aperture ratio. In addition, the black matrix (BM) layer in the above 3 is replaced with a light-transmitting region that is transparent in the center and reflective on the left and right sides, which may further improve the utilization of the external light. Thus, while maintaining the original large viewing angle and low color shift, the light utilization efficiency is further improved.

Through the description of the foregoing examples, a person skilled in the art may clearly understand that the methods of the above embodiment may be implemented by software in combination with a universal hardware platform, or by hardware. Based on such understanding, the above technical solutions essentially or the part contributing to the related art may be embodied in the form of a software product. The software product may be stored in a computer readable storage medium (such as a ROM/RAM, a magnetic disk, or an optical disk). The computer readable storage medium includes several instructions for instructing a computer device (which may be a personal computer, a server, a network device, or the like) to execute the methods described in the embodiments.

The above description describe only some embodiments of the present disclosure, and is not intended to limit the protection scope of the present disclosure. Any modification, equivalent replacement, improvement and the like made within the spirit and principle of the disclosure are comprised in the protection scope of the disclosure.

The above description is only the description of embodiments of the disclosure to enable a person skilled in the art to understand or implement the disclosure. Various modifications to these embodiments will be apparent to a person skilled in the art, and general principles defined herein may be implemented in other embodiments without departing from the spirit or scope of the disclosure. Thus, the disclosure is not limited to the embodiments shown herein, but conforms to the widest scope consistent with the principles and novel characteristics applied herein.

What is claimed is:

1. A display panel comprising: a plurality of color resist regions and a plurality of reflection regions, the reflection regions being provided below the color resist regions respectively, wherein
the color resist region comprises a color resist portion and a blank area, and a central point of the blank area coincides with a central point of the color resist region; and
light incident from the blank area is at least partially shone onto the reflection region, and the reflection region is at least configured to reflect the light incident from the blank area to the corresponding color resist region.

2. The display panel of claim 1, wherein the reflection region comprises, on a cross section in a first direction: two first reflective members arranged at a lower-left portion and a lower-right portion of the reflection region, respectively, and the two first reflective members have opposite inclined surfaces and are bilaterally symmetrical with respect to a central axis of the reflection region; and
the two first reflective members are at least configured to reflect the light incident from the blank area to the corresponding color resist region.

3. The display panel of claim 2, wherein the first reflective member is a prism; or
the first reflective member is a transparent base material, and an area defined by the inclined surfaces of the two first reflective members is formed by etching the transparent base material.

4. The display panel of claim 2, wherein an area defined by the inclined surfaces of the two first reflective members has an inverted triangular shape, a V-shape, a trapezoidal shape, a U-shape, or a W-shape along the first direction.

5. The display panel of claim 2, wherein bottoms of the two first reflective members abut against each other or are connected via an arc-shaped reflective member, and an arc-shaped surface of the arc-shaped reflective member is connected to the inclined surfaces of the two first reflective members.

6. The display panel of claim 2, wherein the reflection region further comprises a second reflective member located between the two first reflective members, the second reflective member is bilaterally symmetrical with respect to the central axis of the reflection region, the second reflective member has two side surfaces, and each of the side surfaces is connected to a bottom of one of the first reflective members; and
the light incident from the blank area is reflected by the two side surfaces of the second reflective member and the inclined surfaces of the first reflective members, and then exits from the color resist region at a plurality of angles.

7. The display panel of claim 3, wherein the second reflective member is a triangular prism, a bottom surface of the second reflective member is located at a center of a bottom of the reflection region and aligned with bottom surfaces of the two first reflective members, the two first reflective members are located on the left and right sides of the second reflective member respectively, and two side surfaces of the second reflective member and the inclined surfaces of the two first reflective members form a W-shaped reflective structure.

8. The display panel of claim 7, wherein positions where the two side surfaces of the second reflective member are connected to the bottoms of the first reflective members are aligned with two sides of the blank area respectively, in which a position where a left side surface of the second reflective member is connected to the bottom of the left first reflective member is aligned with a left side of the blank area, and a position where a right side surface of the second reflective member is connected to the bottom of the right first reflective member is aligned with a right side of the blank area.

9. The display panel of claim 2, wherein the display panel further comprises:
a black light-absorbing layer disposed below the reflection region;
the first reflective member is a transparent base material, and an area defined by the inclined surfaces of the two first reflective members is filled with a composite material with a variable refractive index;
in a case where the refractive index of the composite material is adjusted to be greater than a refractive index of the transparent base material, the light incident from the blank area is reflected by the reflection region and then exits from the color resist region; and
in a case where the refractive index of the composite material is adjusted to be equal to a refractive index of the transparent base material, the light incident from the blank area is incident via the reflection region onto the black light-absorbing layer.

10. The display panel of claim 6, further comprising: a black light-absorbing layer disposed below the reflection region;
the first reflective member is a transparent base material, and an area defined by the inclined surfaces of the two first reflective members is filled with a composite material with a variable refractive index;
in a case where the refractive index of the composite material is adjusted to be greater than a refractive index of the transparent base material, the light incident from the blank area is reflected by the reflection region and then exits from the color resist region; and
in a case where the refractive index of the composite material is adjusted to be equal to a refractive index of the transparent base material, the light incident from the blank area is incident via the reflection region onto the black light-absorbing layer.

11. The display panel of claim 2, wherein the first reflective member is a prism; an area defined by the inclined surfaces of the two first reflective members is filled with an electrochromic material; the display panel further comprises an electrode disposed above the electrochromic material;
in a case where the electrochromic material is adjusted to a transparent state through the electrode, the light incident from the blank area is reflected by the reflection region and then exits from the color resist region; and
in a case where the electrochromic material is adjusted to a black state through the electrode, the light incident from the blank area is incident onto the black electrochromic material and is not reflected.

12. The display panel of claim 6, wherein the first reflective member is a prism; an area defined by the inclined surfaces of the two first reflective members is filled with an electrochromic material; the display panel further comprises an electrode disposed above the electrochromic material;
in a case where the electrochromic material is adjusted to a transparent state through the electrode, the light incident from the blank area is reflected by the reflection region and then exits from the color resist region; and
in a case where the electrochromic material is adjusted to a black state through the electrode, the light incident from the blank area is incident onto the black electrochromic material and is not reflected.

13. The display panel of claim 2, wherein the first reflective member is filled with an electrochromic material; the display panel further comprises an electrode disposed at a bottom of the first reflective member;
in a case where the electrochromic material is adjusted to a transparent state through the electrode, the light incident from the blank area is reflected by the reflection region and then exits from the color resist region; and
in a case where the electrochromic material is adjusted to a black state through the electrode, the light incident from the blank area is incident onto the black first reflective member and is not reflected.

14. The display panel of claim 6, wherein the first reflective member is filled with an electrochromic material; the display panel further comprises an electrode disposed at a bottom of the first reflective member;
in a case where the electrochromic material is adjusted to a transparent state through the electrode, the light incident from the blank area is reflected by the reflection region and then exits from the color resist region; and
in a case where the electrochromic material is adjusted to a black state through the electrode, the light incident from the blank area is incident onto the black first reflective member and is not reflected.

15. The display panel of claim 6, wherein a light-transmitting region is disposed between the adjacent color resist regions, and has a transparent middle and a reflective side; the adjacent reflection regions abut against each other, and a position where the adjacent reflection regions abut against each other is aligned with a central axis of the light-transmitting region between the corresponding adjacent color resist regions; and
light incident from the light-transmitting region is reflected by the two side surfaces of the second reflective member and the inclined surfaces of the first reflective members, and then exits from the color resist region and the light-transmitting region at a plurality of angles.

16. The display panel of claim 15, wherein the light-transmitting region is a region having a same height as the color resist region, light incident from above the color resist region is incident from the light-transmitting region to the reflection region, and light reflected by the second reflective member and the first reflective members exits from the light-transmitting region to above the color resist region.

17. The display panel of claim 1, wherein a black matrix is disposed between the adjacent color resist regions, and an edge of the reflection region is aligned with an edge of the corresponding color resist region.

18. The display panel of claim 17, wherein the adjacent reflection regions are spaced apart by a predetermined distance that is equal to a length of the black matrix.

19. The display panel of claim 1, wherein an area of the blank area accounts for less than 50% of an area of the color resist region where the blank area is located.

20. An electronic device comprising a display panel comprising: a plurality of color resist regions and a plurality of reflection regions, the reflection regions being provided below the color resist regions respectively, wherein
the color resist region comprises a color resist portion and a blank area, and a central point of the blank area coincides with a central point of the color resist region; and
light incident from the blank area is at least partially shone onto the reflection region, and the reflection region is at least configured to reflect the light incident from the blank area to the corresponding color resist region.
